(19) United States
(12) Patent Application Publication
(10) Pub. No.: US 2008/0146138 A1
(43) Pub. Date: Jun. 19, 2008

(54) Automotive HVAC with integral dividing wall connectors

(75) Inventor: Richard Sikorski, Macomb, MI (US)

Correspondence Address: Valeo Climate Control Corp.;Intellectual Property Department, 4100 North Atlantic Boulevard, Auburn Hills, MI, 48326, US

(73) Assignee: Valeo Climate Control Corp., Auburn Hills, MI (US)

(21) Appl. No.: 11/639,889

(22) Filed: Dec. 15, 2006

(51) Int. Cl. B60H 1/26

(52) U.S. Cl. 454/143

(57) ABSTRACT

An automotive HVAC unit with a dividing wall comprising 3 dimensional dividing wall contour is provided. Connectors and/or fixation devices are used on the dividing wall so that the wall, along with the main housing wall, forms an air tight seal at an area of connection of the dividing wall and the housing.

An integral dividing wall connector allows other main housing and/or dividing wall connectors to further stabilize and/or enhance the seal between housing and wall parts by use of various fixation devices or attachment means, such as snaps, screws, or clips.

### FIELD OF THE INVENTION

The present invention relates to air conditioning systems consisting of HVAC units, particularly HVAC units for motorized vehicles that are divided into multiple climate zones allowing independent temperature control between said zones. This is accomplished by barriers or walls internal to the unit.

### BACKGROUND OF THE INVENTION

Automobile vehicle manufacturers, due to design considerations, allocate small spaces for air conditioning systems. In general automotive applications, air conditioning systems include an HVAC unit having multiple housings with walls, and internal elements such as air blowers, heating and/or cooling exchangers and doors or baffles. Various elements are either mounted upon or integral to the housings.

HVAC heat exchangers are provided in HVAC housings and are oriented in relationship to the blower and the general direction of air flow in the HVAC housings. In other words, some HVAC units provide for an orientation for such heater assemblies or other elements, directly in line with the direction of air flow.

The HVAC unit can be considered of two modules—a blower module and a distribution module. By distribution module of the HVAC it is meant the part of the HVAC unit where air is heated, cooled or otherwise conditioned, and, the area that leads into the ducts or other channels that eventually distribute conditioned air into the vehicle. The blower module generally consists of an air intake, the device for propulsion of air, e.g., a blower and an air expansion area e.g., a scroll housing.

Air-conditioning assemblies, and, in particular, HVAC units, can use doors or air guidance or air diverting devices, such as baffles, to help ensure the appropriately conditioned air reaches the areas required by the specifications of the vehicle. For example, in some HVAC units, doors, such as slide-type air mix doors, or barrel doors, are designed for an automotive vehicle to control or provide for a ratio between quantities of warm air and cool air reaching the passengers and/or cockpit area of a motorized vehicle.

The architecture or structure of the HVAC unit is also important. HVAC housings, for example, can comprise numerous parts, either to serve as air-conditioning system components or forming air-channeling paths. For example, dividing walls in the main housing are often designed as thin “plates” that tend to warp in the molding process. These plates are typically sandwiched between two or more distribution housings without any secure screw attachments or tongue and groove and therefore tend to rattle. In the assembly process, the doors are inserted into one half of the distribution housing. Then the divider wall is laid over the assembly but not secured until the second half of the distribution housing is used to sandwich the divider wall in place. Therefore the assembly cannot be reoriented until the entire assembly is complete.

Automotive HVAC units, and, in particular, dual zone HVAC units, have often had problems such as divider wall warping and rattle issues. Problems in the prior art for such units has included excessive door rubbing, rattles or rattling at an unacceptable level, and inconsistent results in testing of HVAC units prior to sale.

Dual zone HVAC units have also shown deficiencies in sealing capacities. By sealing capacity, it is meant the capacity to provide for an essentially leak-proof seal between the different climate zone areas. HVAC Housings have often had a number of methods to secure them to each other, such as screws, snaps, and the like, that helped apply pressure to try and create better seals. As automotive air leak requirements become stricter, less air should be allowed to leak out between areas of seals. A design creating a better seal is thus needed.

### SUMMARY OF THE INVENTION

Various aspects of the invention relate to the methods of securing the dividing wall to the housing of the HVAC units. Various aspects provide for fixation devices, for example, attachments such as screw and/or snaps, in combination with a connector, such as a tongue and groove between the dividing wall and the distribution housings, to provide for appropriate seals on multi-zones units. Aspects of the present invention provide for seals and securing methods integral to the dividing wall, thereby providing for a different integration and better seal between parts than found with many prior art HVAC units. The combination of such integral sealing and securing methods between the dividing wall and the HVAC housings provide for an air tight and rattle proof HVAC unit.

Aspects of the present invention relate to an HVAC unit for use in motorized vehicles, (hereinafter referred to as ‘automotive HVAC units’) having housings with a wall between them that serves as a divider of the HVAC unit into zones (a ‘dividing wall’). By providing for a more intimate association between pieces of an HVAC housing into a dividing wall, the dividing wall third dimensional contours and additional features may also be incorporated. For example screw attachments, ribbing, and internal walls that can create various air paths. The combination of a third dimension wall contour and the additional incorporated features, provides for an HVAC unit comprising at least one dividing wall, which itself, as a part, can be molded with reduced warping or otherwise deforming, during the molding operation.

In aspects of the present invention, the dividing wall is secured to various main HVAC housing parts at an area of connection, by a connector and/or fixation device or attachment, (hereafter collectively referred to a fixation devices) for example, by screws or snaps to hold the assembly together. In another words, the snaps, clips, screws, or other fixation devices serve to make sure that the dividing wall stays attached or ‘connected to’ the main housing portions or pieces. For example, one main housing portion (first main housing piece) and a second main housing portion (second main housing piece) share the dividing wall in such a way, for example, that fixation devices such snaps or and/or clips hold the dividing wall interlocked or integrated with each piece of the main housing wall. Also, for example, one fixation device, such as a screw, could be used to join all three parts—left housing piece, 3 dimensional contour dividing wall contour at area of connection, and right housing piece, in various aspects of the present invention.

In various aspects of the present invention, in addition to the third dimension (3 dimensional contour) given to the dividing wall that helps reduce warping, connectors such as screw bosses and/or tongue and groove features may be added. In the various aspects, the at least two pieces of the main housings can be secured to the dividing wall without increasing the count of screws in the assembly. In general, HVAC units that include dividing walls can cause rattling. The aspects of the present invention, comprising screw bosses and/or tongue and groove features to secure the main housing to the dividing wall without a resultant increase in rattling.

The aspects of the present invention, therefore, diminish greatly the possibility of door rubbing. By maintaining a straighter (non-warping) dividing wall the relationship between the doors and the dividing wall stay constant. The aspects of the present invention diminish the possibility of rattling caused by the tolerances that must be allowed for between the dividing wall and the main housings due to warping. Also, the addition of fixation devices, in addition to, for example, connectors such as screws bosses or tongue and/or groove features, produce a higher quality HVAC unit that reduces future development time for automotive HVAC designs by providing units that perform more consistently on vehicle testing; provide for easier assembly of complete automotive HVAC units; provide for a better mold process for the dividing wall and provide for better dimensional stability of HVAC parts, and, in particular, where present on a dividing wall comprising part of the distribution module of the HVAC unit.

In particular, aspects of the present invention relate to compact air conditioning apparatuses comprising elements for a mix door mechanism. Providing 3 dimensional dividing wall contours, and, for example, attachments on the dividing wall provide for an ease of assembly not seen in convention compact HVAC units. For example, in convention HVAC units, the elements of the mix door (door that provides for a “mix” of different streams of air down stream) are assembled into a housing unit one by one during assembly operations of various mode doors (doors that provide the distribution of the air e.g. to the vent or to the feet). As a second step, it is necessary to install a driving device for moving the mix door after the mix door mechanism is installed in the unit housing. This also increases steps for assembling the air conditioning apparatus.

Aspects of the present invention, therefore, avoid many of these assembly difficulties by integrally holding the dividing wall between the two distribution housings at the area of connection with the 3 dimensional dividing wall contour, and a better seal between the two HVAC or “climate” zones in a multi-zone HVAC is obtained. The use of 3 dimensional wall contours on the dividing wall, and, as appropriate, fixation devices either directly attached to the 3 dimensional dividing wall contours or the housing pieces at the area of connection of the 3 dimensional dividing wall contours and the main housing wall pieces, means that the HVAC unit is better held together to allow for a greater seal. Aspects of the present invention, therefore, allow for a better seal between zones in multi-zone, such as a dual zone, HVAC units.

In aspects of the present invention, the dividing wall is a portion of the distribution module of the HVAC unit. The dividing wall, for example, may be given contours or depth that allows for a three dimensional effect on the dividing wall similar to that normally found on other housing portions of an HVAC unit. By three dimensional effect and dividing wall 3 dimensional contours or (3 dimensional dividing wall contours) it is meant that the dividing wall includes contours, such as walls, towers, and ribs, that would cause the wall to have elevations or depressions or otherwise have adjustments to the amount of material at the level of the plane of the wall, that extend or are depressed from that plane, not unlike such areas of adjustment normally only be found on the main housing portions. For example, an area of the dividing wall may be elevated or additional material provided so that a boss or screw may be attached to, or enter into the wall at that area, without affecting the rest of the HVAC housing or wall.

The dividing wall, therefore, may have contours or dimensions attached, molded or otherwise incorporated into the dividing wall. These 3 dimensional dividing wall contours, for example, elevations or depressions, allow for the dividing wall to have more mass, for example, at a designated area of the dividing wall, allowing integration of connectors, e.g. screw bosses or tongue or groove features, to fasten the wall to main housings, thus increasing both wall stability and wall strength, and, in effect, assuring its relative positioning and better seal capacity between the two distribution housing pieces.

Aspects of the present invention, therefore, provide for a significant third dimensional width in part of the dividing wall as compared to other parts of the dividing wall, in various aspects, that ends in tongue or groove and mates to at least one main housing piece, or to two or more main housing pieces of the main housing.

In various aspects of the present invention, material mass added to the dividing wall is counter balanced by diminution of necessary material mass on the housing. For example, by adding material mass in the third dimension to the dividing wall, less material is necessary to ensure appropriate connection, and eventually, appropriate sealing on the mating housings; reducing such material on the housing where mating occurs means that tool draw is reduced on those parts of the HVAC unit with the deepest draw. For example, by having a dividing wall with attachments, as opposed to attachments on the housing itself, less material needs to be drawn at the area of the housing wall when removed from the mold, thereby reducing risk of weak or malformation due to draw on the housing unit. The result is that the molding of the parts will lead to a sealed HVAC unit that is more dimensionally stable, and more robust, than otherwise possible.

Aspects of the present invention also provide for a process for making an automotive HVAC unit comprising the steps of: molding a first, second and third piece of housing of an HVAC out of plastics or any other polymeric materials having appropriate thermoplastic properties; providing for HVAC internal elements such as walls, door bearings and attachments on the first, second and the third piece of the housing; and assembling the first, second and third piece of the housing in such a way that each piece is attached, interlocked or otherwise forms an appropriate seal with one another, such that a complete HVAC module is formed; attaching a dividing wall to half the housing (which pieces) to hold the HVAC elements in place, and turning the entire HVAC unit over to provide for the addition of doors in the second half of the distribution module and the assembly process can be completed, are also features in various processes for making an automotive HVAC unit of the present invention.

### BRIEF DESCRIPTION OF THE DRAWINGS

FIG. 1 is a cross sectional view of a wall of an HVAC unit, having various three dimensional elements (104) on the dividing wall, in accordance with an aspect of the present invention.

FIG. 2 is a cross sectional view of a wall of an HVAC unit of the prior art, having various wall designs with attachment problem to other parts of the unit.

FIG. 3 is a sectional view of a two-piece housing and attachment of the prior art, with dividing wall positioned adjacent to, and not contributing towards, the final attachment of housing pieces.

FIG. 4 is a sectional view of a two piece housing (401),(402) and attachment (409), with attachment (407) integral to the dividing wall, as well as contributing towards the final attachment of housing pieces, in accordance with an aspect of the present invention.

FIG. 5 is a sectional view of a two piece housing and attachment, with dividing wall connectors integral to the two pieces of the housing wall, contributing towards the final attachment of housing pieces, in accordance with an aspect of the present invention.

FIG. 6 is a sectional view of a two piece housing and attachment, with dividing wall connectors integral to the two pieces of the housing wall, contributing towards the final attachment of housing pieces, in accordance with an aspect of the present invention.

### PREFERRED EMBODIMENTS OF THE PRESENT INVENTION

Aspects of the present invention provide for the presence of an HVAC unit having a multiple piece housing with attachment means or attachment features to ensure both an appropriate seal as well as an appropriate securing method. The aspects of the present invention provide for attachment features, including for example, attachments that either are aided by the presence of a fixation device. By fixation device is meant a screw or clip or snap, or any other such means to add stability. The fixation device, is, therefore meant a means to hold in place and/or provide a better seal, for portions of the HVAC unit, and, in various aspects of the present invention, can be integrated or attached so that it helps secures the attachment feature function. Also, for example, connectors such as tongue and groove connections or screw bosses between walls of the housing and 3 dimensional dividing wall contours provide for a tight seal.

Aspects of the present invention provide an improved heating or air-conditioning system requiring a small amount of installation space, for example, under the automobile dash or dash-board. Different temperature-controlled air streams can be fed to a plurality of air-conditioning zones in an HVAC unit that forms part of the system. Appropriate mixing of cold air and warm air takes place in the heating or air-conditioning system, with the result that the air emerging from air-outlet openings in each respective air-conditioning zone is not in divided form, i.e., the emerging air has to have a constant temperature over the outlet cross section. More specifically, by providing for a dividing wall with better sealing characteristics, a more manageable air temperature across air outlet openings is possible.

The housing of such HVACs is, in various embodiments, a more than one piece main housing. By more than one piece main housing it is meant a housing that has two or more pieces that can be brought together in a way to form a seal (and, preferably, as air tight seal) between pieces of the housing.

The main housing can comprise one zone or be of dual zone or more in design. By one zone it is meant is one temperature control area. By two zones it is meant two temperature control areas. In multi-zone HVAC units, a dividing wall separates the main housing units into zones that have, therefore, somewhat different characteristics.

In other aspects of the present invention, a heating or air-conditioning system for a motor vehicle comprising a heater core for producing warm air, at least one cold-air duct (routed through or past the heater core) an air-mixing space which adjoins the heater core, (and or evaporator, if present), in the HVAC unit, is provided. The heater core opposes the direction of air flow and the HVAC unit is divided, by at least one dividing wall, into individual mixing spaces in which air can be mixed by air-stream control elements to a certain temperature in each zone and, from there, can be fed to an associated air-conditioning zone. Each mixing space temperature is controlled by doors or flaps which manage cold air in the cold-air duct and warm-air from directly on an outlet side of the heater core.

In various aspects of the present invention, the dividing wall, at the area or areas of connection with the main housing pieces where it has its 3 dimensional contours, has ends capable of interfacing, interlocking or becoming integral with the two housings of the distribution module (in general, the two housing sections of a main housing on an HVAC unit or module). These ends can comprise different elements or parts. For example, in addition to connectors at the connecting area to the housing, the dividing wall may comprise fixation devices such as, screws, snaps or clips.

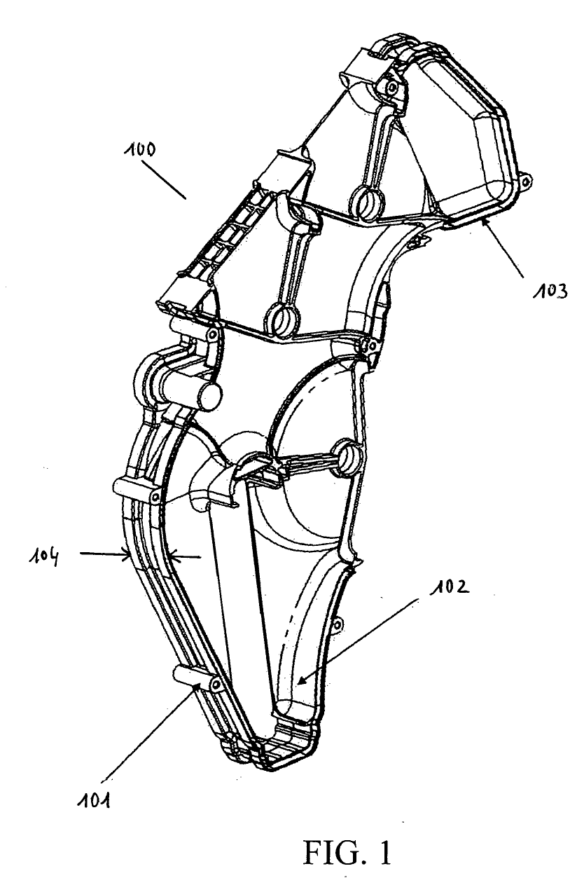

FIG. 1 shows a dividing wall of an HVAC unit (100). Screw boss (101) and tongue and groove (103) are shown, as are contours of wall (102) with added 3^{rd} dimension three dimensional dividing wall contour (104).

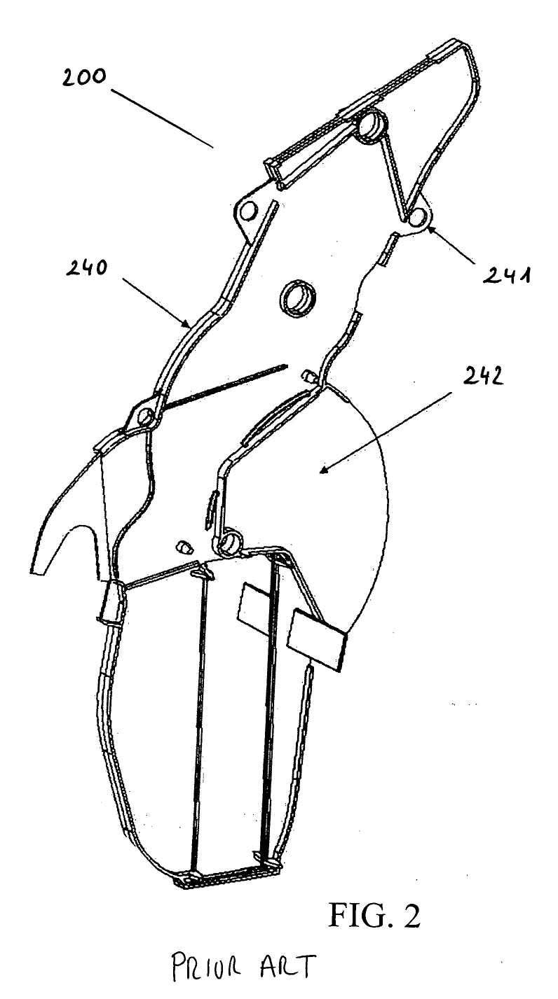

FIG. 2 shows part of a prior art of a dividing wall of an HVAC unit (200) having rib design (240) and eyelets (241) wherein flat wall design (242) warps due to lack of contours.

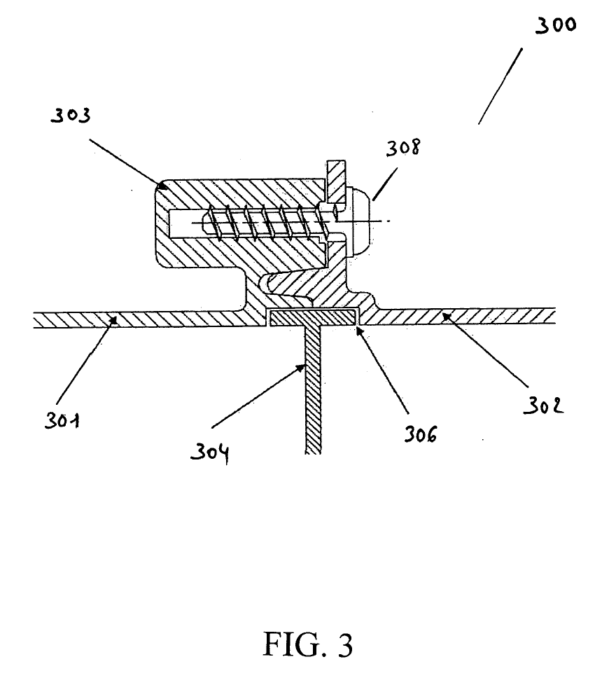

FIG. 3 shows prior art of an attachment of housing walls (301, 302), wherein a dividing wall (304) is sandwiched between the housing walls. A gap (306) must be allowed for tolerances failing to create an airtight seal with the main housing parts (301, 302). A screw boss (303) with screw (308) is also illustrated.

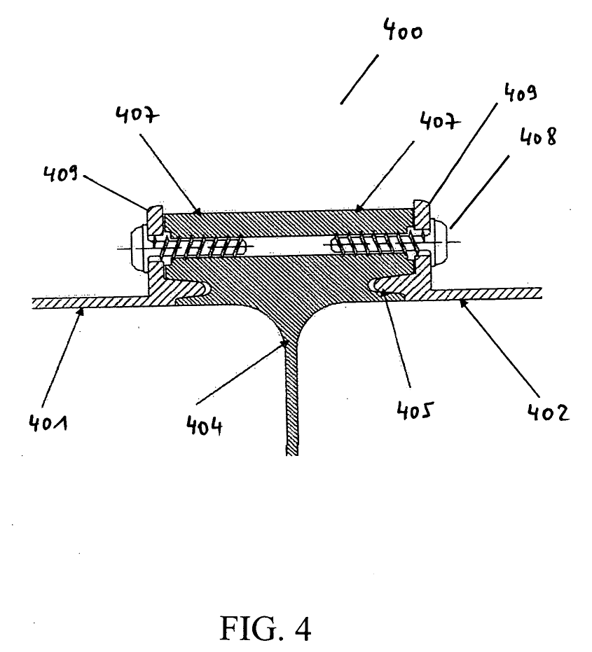

FIG. 4 shows an aspect of the present invention having main housing pieces (401, 402) and dividing wall (404). An air tight seal is formed at tongue and groove (405) between dividing wall (404) and distribution housing pieces 401,402) and screw (408) is found within screw boss (407) as provided. By having a screw boss on each side of the dividing wall, the entire unit may be flipped over during assembly, unlike the situation in, for example, FIG. 3, wherein stability could be compromised.

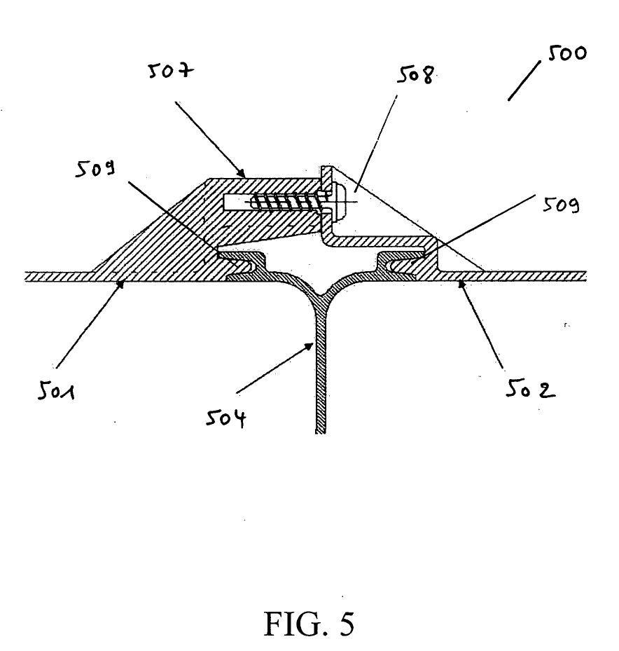

FIG. 5 illustrates a dividing wall (504) integral to housing pieces (501, 502) having tongue and groove (509) air tight seals are created at areas A and B. Screw boss (507) and screw (508) are present, and use of one screw boss (507) allows the dividing wall (504) to be ‘sandwiched’ between the two main housing pieces (501, 502), but still creating an air tight seal without potential rattle.

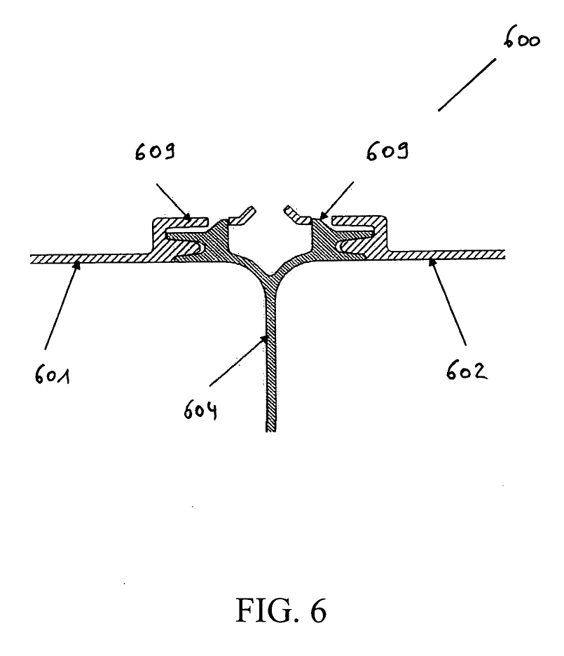

FIG. 6 shows a snap type attachment (609). Snaps (609) are provided on the distribution housing portion/part (601) and (602) with dividing wall (604). Areas of air-tight seal are found at areas A and B.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. An automotive multi-zone HVAC unit comprising:
a main housing comprising two or more housing pieces; and
at least one dividing wall between the at least two pieces of the main housing,
wherein the dividing wall is connected to at least one of the two or more main housing pieces, thereby forming a seal at an area of connection

2. An automotive multi-zone HVAC unit as in claim 1, wherein the seal at the area of connection is basically air-tight.

3. An automotive multi-zone HVAC unit as in claim 2, wherein the dividing wall comprises a 3 dimensional dividing wall contour at the area of connection of sufficient mass to allow it to be connected to at least one of the two pieces of the main housing.

4. An automotive multi-zone HVAC unit as in claim 3, wherein the 3 dimensional dividing wall contour at the area of connection separates the at least two pieces of the main housing.

5. An automotive multi-zone HVAC unit as in claim 4, wherein the 3 dimensional dividing wall contour at the area of connection ends in a connector that is connected to at least one of the two pieces of the main housing.

6. An automotive multi-zone HVAC unit as in claim 4, wherein the 3 dimensional dividing wall contours at the area of connection ends in a tongues or grooves such that it is connected to at least two of the pieces of the main housing at least two areas of connection.

7. An automotive multi-zone HVAC unit as in claim 5, further comprising at least one attachment or fixation device between at least one of the at least two pieces of the main housing and the 3 dimensional dividing wall contour at the area of connection

8. An automotive multi-zone HVAC unit as in claim 6, wherein at least one attachment or fixation device is found between at least two pieces of the main housing and the 3 dimensional dividing wall contour at least two areas of connection.

9. An automotive multi-zone HVAC unit as in claim 7, wherein at least one attachment or fixation device is found between at least two pieces of the main housing and the 3 dimensional dividing wall contour at least two areas of connection.

10. An automotive multi-zone HVAC unit as in claim 5, further comprising a fixation device between at least two pieces of the main housing.

11. An automotive multi-zone HVAC unit as in claim 5, wherein the 3 dimensional dividing wall contour is in the shape of a tongue and groove that is integrated or mated with at least two pieces of the main housing.
